(19) United States
(12) Patent Application Publication
(10) Pub. No.: US 2020/0394347 A1
(43) Pub. Date: Dec. 17, 2020

(54) METHOD FOR ASSESSING FATIGUE DAMAGE AND FATIGUE LIFE BASED ON ABAQUS

(71) Applicant: Sichuan University, Chengdu (CN)

(72) Inventors: Qingyuan WANG, Chengdu (CN); Hong ZHANG, Chengdu (CN); Yongjie LIU, Chengdu (CN); Chong WANG, Chengdu (CN); Lang LI, Chengdu (CN); Chao HE, Chengdu (CN)

(73) Assignee: Sichuan University, Chengdu (CN)

(21) Appl. No.: 15/931,608

(22) Filed: May 14, 2020

(30) Foreign Application Priority Data
Jun. 12, 2019 (CN) 201910507043.1

(51) Int. Cl. G06F 30/23; G06F 30/10

(52) U.S. Cl. CPC G06F 30/23; G06Q 50/08; G06F 30/10

(57) ABSTRACT

A method for assessing fatigue damage and fatigue life based on Abaqus is provided. The micro-macroscopic scale coupled model is based on the macroscopic representative area and the microstructure characterization of the material, and the microscopic sub-model is established by the Voronoi algorithm. The algorithm has good cross-platform compatibility and portability, fundamentally solves the technical problem of micro-macroscopic multi-scale coupling and establishes and applies the multi-scale coupled model to the fatigue damage and life assessment. The micro-macroscopic multi-scale coupled fatigue damage and life assessment model and algorithm of the material is capable of both considering the fatigue damage evolution on a microscopic scale and assessing the fatigue life, as well as calculating and assessing the two physical parameters on a macroscopic scale, so as to predict the fatigue damage and life of the whole workpiece.

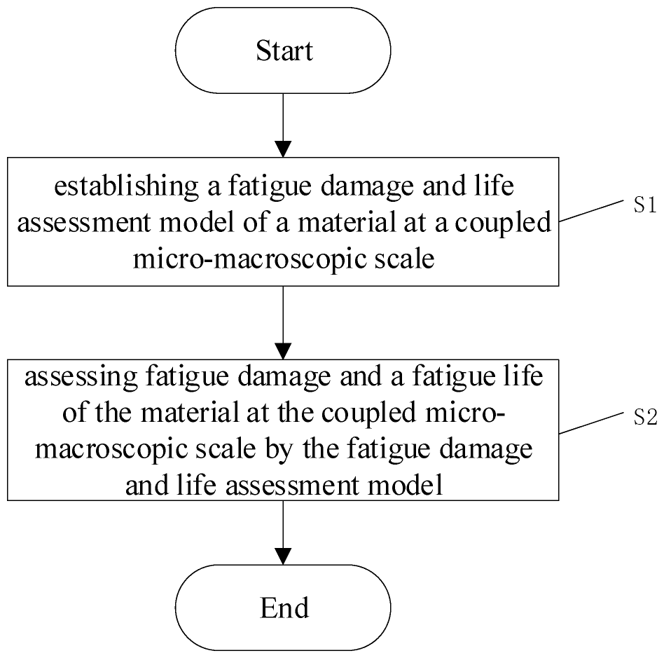

### CROSS REFERENCE TO THE RELATED APPLICATIONS

This application is based upon and claims priority to Chinese Patent Application No. 201910507043.1, filed on Jun. 12, 2019, the entire contents of which are incorporated herein by reference.

### TECHNICAL FIELD

The present disclosure relates to finite element technologies, and more particularly, to a method for assessing fatigue damage and fatigue life based on ABAQUS.

### BACKGROUND

The assessment and calculation of fatigue damage and fatigue life of materials based on the finite element technology (such as software for finite element analysis (FEA), like that which is managed and sold by Dassault Systems Simulia Corp., Johnston, R.I., under the trademark ABAQUS) remains an urgent problem to be solved in engineering. The problem has been an area of concentration in the finite element method calculation. The existing problems are as follows: (1) The multi-axis fatigue of complex workpieces and the corresponding stress-strain response over time. (2) The fatigue model needs a smaller mesh size to describe the fatigue damage evolution and the surface stress/strain gradient distribution of the fatigue model. In order to assess and calculate the fatigue damage and fatigue life of materials, on one hand, various fatigue loading conditions need to be considered; therefore, it is important to focus on the computational efficiency of the algorithm for guiding people to solve practical engineering problems.

At present, the fatigue calculation is realized by further developing the post-processing mode of the current commercial common software, and the technical core thereof is to re-analyze and process the finite element results (stress/strain) based on the fatigue theory. Only the fatigue life assessment is accomplished, however, and the process of fatigue damage cannot be assessed. Also, the whole process is calculated by using the existing software solver, which significantly limits the data processing speed and computational efficiency. Furthermore, this process is based on the calculation on a macroscopic scale without considering the multi-scale micro-macroscopic coupled model, and the simulation results merely show the fatigue life assessment and other parameters. Existing fatigue life prediction methods are thus trapped by many limitations and can only be used as qualitative calculation research.

### SUMMARY

In view of the above-mentioned shortcomings in the prior art, in order to solve the problems that the micro-macroscopic multi-scale coupled behavior and damage of materials are not contained in current fatigue life assessment algorithms, the present disclosure provides a method for assessing fatigue damage and fatigue life based on Abaqus.

In order to achieve the above-mentioned objective of the present disclosure, the technical solution adopted by the present disclosure is as follows. A method for assessing fatigue damage and fatigue life based on Abaqus, including the following steps:

S1, establishing a fatigue damage and life assessment model of a material at a coupled micro-macroscopic scale;

S2, assessing, by the fatigue damage and life assessment model, fatigue damage and a fatigue life of the material at the coupled micro-macroscopic scale.

Further, step S1 specifically includes:

S11, establishing, based on an actual engineering problem, a macroscopic geometric model;

S12, selecting, based on a microstructure characterization of the material, a representative area to establish a microscopic sub-model by a Voronoi algorithm;

S13, establishing, based on the macroscopic geometric model and the microscopic sub-model, a homogeneous elastic-plastic model based on the macroscopic model and a crystal plasticity-based elastic-plastic constitutive model, respectively; wherein the microstructure characterization of the material is considered in the crystal plasticity-based elastic-plastic constitutive model;

S14, calculating a microscopic damage increment of the selected area by the crystal plasticity-based elastic-plastic constitutive model, and calculating a macroscopic damage increment of the homogeneous elastic-plastic model by accumulating damage variable values;

S15, determining, by the microscopic damage increment and the macroscopic damage increment, whether the microscopic sub-model and the macroscopic model are failed; when the microscopic sub-model and the macroscopic model are failed, proceeding to step S16, otherwise proceeding to step S17;

S16, establishing the fatigue damage and life assessment model with considering the microscopic damage increment and the macroscopic damage increment;

S17, directly establishing a life assessment model without considering the fatigue damage.

Further, the microscopic damage increment in step S14 is calculated by the following formula:

$$d {D}_{micro} = \frac{1}{{( 1 - {D}_{micro} )}^{β}} {( \frac{λ}{} )}^{m} d t ,$$

where, D_{micro} represents the microscopic damage increment, λ represents a crack initiation length ratio, [symbol] represents an average stress, β and m represent a microscale material coefficient and a microscale stress sensitivity parameter of the material, respectively, and t represents time;

The macroscopic damage increment is calculated by the following formula:

$$d {D}_{m a c r o} = {\sum }_{1}^{N} d {D}_{micro} / N , N = 1 , 2 , 3 … ,$$

where, D_{macro} represents the macroscopic damage increment, and N represents the number of crystal grains.

Further, the fatigue damage and life assessment model in step S16 is expressed by the following formula:

$${N}_{f} = {N}_{micro} + {N}_{macro} = \frac{2 πE {γ}_{s} - 4 {σ}^{2} a ( 1 - {v}^{2} )}{π {Eft}_{m} ( Δ τ / 2 ) ( Δγ / 2 )} + {\frac{{m}^{β}}{( 1 - α ) ( 1 + β )} [ \frac{{σ}_{a} ( 1 + \frac{E}{{E}_{0}} )}{( 1 - n {σ}_{m} )} ]}^{- β} ,$$

where, N_{f} represents a fatigue life; N_{micro} represents a microscopic crack initiation and propagation life; N_{macro} represents a macroscopic steady state crack propagation life; γₛ represents surface free energy of the material; Δγₚ represents a plastic shear strain increment; Δτ represents a shear stress increment; tₘ represents a width of a maximum persistent slip band (PSB); f represents an energy efficiency coefficient; n, α, β and m represent a macroscale stress concentration coefficient, a macroscale stress sensitivity parameter of the material, a microscale material coefficient and a microscale stress sensitivity parameter of the material, respectively; σ_{α} and σₘ represent a stress amplitude and an average stress, respectively; E and E₀ respectively represent an elastic modulus after being damaged and an elastic modulus before being damaged; σ represents a stress; and ν represents a crack propagation speed.

Further, step S2 specifically includes:

S21, determining, according to a lattice type of a metal material, a number n of solution variables of the fatigue damage and life assessment model;

S22, selecting an iterative variable and a convergence and precision control parameter, and obtaining an iterative initial value of the elastic-plastic model based on a linear algorithm;

S23, calculating an iterative variable in the n^{th} iteration of the plasticity-based elastic-plastic constitutive model based on a non-linear algorithm or a fast Fourier transform (FFT) algorithm, and obtaining an iterative variable in the (n+1)^{th} iteration of the plasticity-based elastic-plastic constitutive model and a consistent tangent stiffness matrix by an Euler integral;

S24, assessing the fatigue damage and the fatigue life at the coupled micro-macroscopic scale based on the iterative variable in the (n+1)^{t} iteration and the consistent tangent stiffness matrix.

Further, the lattice type in step S21 includes a face-centered cubic metal material, a body-centered cubic metal material, and a close-packed cubic metal material. The number of solution variables of the face-centered cubic metal material is 12. The number of solution variables of the body-centered cubic metal material is 48. The number of solution variables of the close-packed cubic metal material is 6.

The advantages of the present disclosure are as follows. The micro-macroscopic scale coupled model provided by the present disclosure is based on the macroscopic representative area and the microstructure characterization of the material, and the microscopic sub-model is established by the Voronoi algorithm, which has good cross-platform compatibility and portability, fundamentally solves the technical problem of micro-macroscopic multi-scale coupling, and establishes and applies the multi-scale coupled model for assessing the fatigue damage and the fatigue life. Moreover, in the present disclosure, the micro-macroscopic multi-scale coupled model and algorithm for assessing the fatigue damage and the fatigue life of the material is capable of both considering the fatigue damage evolution on a microscopic scale and assessing the fatigue life, as well as calculating and assessing the two physical parameters on a macroscopic scale, so as to predict the fatigue damage and life of the whole workpiece. The present disclosure provides significant theoretical support and technical basis for assessing the fatigue damage and the fatigue life of materials, which is highly innovative and has important engineering application value.

### BRIEF DESCRIPTION OF THE DRAWINGS

FIGURE is a flow chart of the present disclosure.

### DETAILED DESCRIPTION OF THE EMBODIMENTS

The specific embodiments of the present disclosure are described hereinafter to facilitate an understanding of the present disclosure. It should be noted that the present disclosure is not limited to the scope of the specific embodiments, those skilled in the art can understand that various changes made within the spirit and scope of the claims of the present disclosure are obvious, and all inventions and creations utilizing the concept of the present disclosure are protected.

As shown in FIGURE, a method for assessing fatigue damage and fatigue life based on Abaqus includes the following steps:

S1, a fatigue damage and life assessment model of a material at a coupled micro-macroscopic scale is established;

Step S1 specifically includes:

S11, a macroscopic geometric model is established based on an actual engineering problem;

S12, based on a microstructure characterization of the material, a representative area is selected to establish a microscopic sub-model by a Voronoi algorithm;

S13, based on the macroscopic geometric model and the microscopic sub-model, a homogeneous elastic-plastic model based on the macroscopic model and a crystal plasticity-based elastic-plastic constitutive model are respectively established; wherein the microstructure characterization of the material is considered in the crystal plasticity-based elastic-plastic constitutive model;

S14, a microscopic damage increment of the selected area is calculated by the crystal plasticity-based elastic-plastic constitutive model, and a macroscopic damage increment of the homogeneous elastic-plastic model is calculated by accumulating damage variable values.

The microscopic damage increment is calculated by the following formula:

$$d {D}_{micro} = \frac{1}{{( 1 - {D}_{micro} )}^{β}} {( \frac{λ}{} )}^{m} d t ,$$

where, D_{micro} represents the microscopic damage increment, λ represents a crack initiation length ratio, [symbol] represents an average stress, β and m represent a microscale material coefficient and a microscale stress sensitivity parameter of the material, respectively, and t represents time;

The macroscopic damage increment is calculated by the following formula:

$$d {D}_{m a c r o} = {\sum }_{1}^{N} d {D}_{micro} / N , N = 1 , 2 , 3 … ,$$

where, D_{macro} represents the macroscopic damage increment, and N represents a number of crystal grains.

S15, using the microscopic damage increment and the macroscopic damage increment to determine whether the microscopic sub-model and the macroscopic model are failed; when the microscopic sub-model and the macroscopic model are failed, proceeding to step S16, otherwise proceeding to step S17.

S16, the fatigue damage and life assessment model with considering the microscopic damage increment and the macroscopic damage increment is established.

The fatigue damage and life assessment model are expressed by the following formula:

$${N}_{f} = {N}_{micro} + {N}_{macro} = \frac{2 πE {γ}_{s} - 4 {σ}^{2} a ( 1 - {v}^{2} )}{π {Eft}_{m} ( Δ τ / 2 ) ( Δγ / 2 )} + {\frac{{m}^{β}}{( 1 - α ) ( 1 + β )} [ \frac{{σ}_{a} ( 1 + \frac{E}{{E}_{0}} )}{( 1 - n {σ}_{m} )} ]}^{- β} ,$$

where, N_{f} represents a fatigue life; N_{micro} represents a microscopic crack initiation and propagation life; N_{macro} represents a macroscopic steady state crack propagation life; γₛ represents surface free energy of the material; Δγₚ represents a plastic shear strain increment; Δτ represents a shear stress increment; tₘ represents a width of a maximum persistent slip band (PSB); f represents an energy efficiency coefficient; n, α, β and m represent a macroscale stress concentration coefficient, a macroscale stress sensitivity parameter of the material, a microscale material coefficient and a microscale stress sensitivity parameter of the material, respectively; σ_{α} and σₘ represent a stress amplitude and an average stress, respectively; E and E₀ respectively represent an elastic modulus after being damaged and an elastic modulus before being damaged; σ represents a stress; and ν represents a crack propagation speed.

S17, a life assessment model without considering the fatigue damage is directly established.

S2, the fatigue damage and the life of the material at the coupled micro-macroscopic scale are assessed by the fatigue damage and life assessment model.

Step S2 specifically includes:

S21, according to a lattice type of a metal material, a number n of solution variables of the fatigue damage and life assessment model is determined.

The lattice type includes a face-centered cubic metal material, a body-centered cubic metal material, and a close-packed cubic metal material. The number of solution variables of the face-centered cubic metal material is 12. The number of solution variables of the body-centered cubic metal material is 48. The number of solution variables of the close-packed cubic metal material is 6.

S22, an iterative variable, and a convergence and precision control parameter are selected, and an iterative initial value of the elastic-plastic model is obtained based on a linear algorithm;

S23, an iterative variable in the n^{th} iteration of the plasticity-based elastic-plastic constitutive model is calculated based on a non-linear algorithm or a fast Fourier transform (FFT) algorithm, and an iterative variable in the (n+1)^{th} iteration of the plasticity-based elastic-plastic constitutive model and a consistent tangent stiffness matrix are obtained by an Euler integral.

S24, the fatigue damage and the fatigue life at the coupled micro-macroscopic scale are assessed based on the iterative variable in the (n+1)^{th} iteration and the consistent tangent stiffness matrix.

The micro-macroscopic scale coupled model provided by the present disclosure is based on the macroscopic representative area and the microstructure characterization of the material, and the microscopic sub-model is established by the Voronoi algorithm, which has good cross-platform compatibility and portability, fundamentally solves the technical problem of micro-macroscopic multi-scale coupling, and establishes and applies the multi-scale coupled model for the fatigue damage and life assessment. Moreover, in the present disclosure, the micro-macroscopic multi-scale coupled fatigue damage and life assessment model and algorithm of the material is capable of both considering the fatigue damage evolution on a microscopic scale and assessing the fatigue life, as well as calculating and assessing the two physical parameters on a macroscopic scale, so as to predict the fatigue damage and life of the whole workpiece. The present disclosure provides significant theoretical support and technical basis for the fatigue damage and life assessment of materials, which is highly innovative and has important engineering application value.

What is claimed is:

1. A method for assessing fatigue damage and a fatigue life based on Abaqus, comprising the following steps:
S1, establishing a fatigue damage and life assessment model of a material at a coupled micro-macroscopic scale; and
S2, assessing, by the fatigue damage and life assessment model, the fatigue damage and the fatigue life of the material at the coupled micro-macroscopic scale.

2. The method for assessing the fatigue damage and the fatigue life based on the Abaqus according to claim 1, wherein, the step S1 specifically comprises the following steps:
S11, establishing, based on an actual engineering problem, a macroscopic geometric model;
S12, selecting, based on a microstructure characterization of the material, a representative area to establish a microscopic sub-model by a Voronoi algorithm;
S13, establishing, based on the macroscopic geometric model and the microscopic sub-model, a homogeneous elastic-plastic model and a crystal plasticity-based elastic-plastic constitutive model, respectively; wherein the homogeneous elastic-plastic model is based on the macroscopic geometric model, and the microstructure characterization of the material is considered in the crystal plasticity-based elastic-plastic constitutive model;
S14, calculating a microscopic damage increment of the representative area by the crystal plasticity-based elastic-plastic constitutive model, and calculating a macroscopic damage increment of the homogeneous elastic-plastic model by accumulating damage variable values;
S15, determining, by the microscopic damage increment and the macroscopic damage increment, whether the microscopic sub-model and the macroscopic geometric model are failed; when the microscopic sub-model and the macroscopic geometric model are failed, proceeding to step S16; when the microscopic sub-model and the macroscopic geometric model are not failed, proceeding to step S17;
S16, establishing the fatigue damage and life assessment model with considering the microscopic damage increment and the macroscopic damage increment; and
S17, establishing a life assessment model without considering the fatigue damage.

3. The method for assessing the fatigue damage and the fatigue life based on the Abaqus according to claim 2, wherein, the microscopic damage increment in the step S14 is calculated by the following formula:
$$d {D}_{micro} = \frac{1}{{( 1 - {D}_{micro} )}^{β}} {( \frac{λ}{} )}^{m} d t ,$$
where, D_{micro} represents the microscopic damage increment, λ represents a crack initiation length ratio, [symbol] represents an average stress, β and m represent a microscale material coefficient and a microscale stress sensitivity parameter of the material, respectively, and t represents time; and
the macroscopic damage increment is calculated by the following formula:
$$d {D}_{m a c r o} = {\sum }_{1}^{N} d {D}_{micro} / N , N = 1 , 2 , 3 … ,$$
where, D_{macro} represents the macroscopic damage increment, and N represents a number of crystal grains.

4. The method for assessing the fatigue damage and the fatigue life based on the Abaqus according to claim 2, wherein, the fatigue damage and life assessment model in the step S16 is expressed by the following formula:
$${N}_{f} = {N}_{micro} + {N}_{macro} = \frac{2 πE {γ}_{s} - 4 {σ}^{2} a ( 1 - {v}^{2} )}{π {Eft}_{m} ( Δ τ / 2 ) ( Δγ / 2 )} + {\frac{{m}^{β}}{( 1 - α ) ( 1 + β )} [ \frac{{σ}_{a} ( 1 + \frac{E}{{E}_{0}} )}{( 1 - n {σ}_{m} )} ]}^{- β} ,$$
where, N_{f} represents the fatigue life; N_{micro} represents a microscopic crack initiation and propagation life; N_{macro} represents a macroscopic steady state crack propagation life; γₛ represents surface free energy of the material; Δγₚ represents a plastic shear strain increment; Δτ represents a shear stress increment; tₘ represents a width of a maximum persistent slip band (PSB); f represents an energy efficiency coefficient; n, α, β and m represent a macroscale stress concentration coefficient, a macroscale stress sensitivity parameter of the material, a microscale material coefficient and a microscale stress sensitivity parameter of the material, respectively; σ_{α} and σₘ represent a stress amplitude and an average stress, respectively; E and E₀ respectively represent an elastic modulus after being damaged and an elastic modulus before being damaged; σ represents a stress; and ν represents a crack propagation speed.

5. The method for assessing the fatigue damage and the fatigue life based on the Abaqus according to claim 1, wherein, the step S2 specifically comprises:
S21, determining, according to a lattice type of a metal material, a number n of solution variables of the fatigue damage and life assessment model;
S22, selecting an iterative variable and a convergence and precision control parameter, and obtaining an iterative initial value of a crystal plasticity-based elastic-plastic constitutive model based on a linear algorithm;
S23, calculating the iterative variable in an nth iteration of the crystal plasticity-based elastic-plastic constitutive model based on a non-linear algorithm or a fast Fourier transform (FFT) algorithm, and obtaining the iterative variable in an (n+1)^{th} iteration of the crystal plasticity-based elastic-plastic constitutive model and a consistent tangent stiffness matrix by an Euler integral; and
S24, assessing the fatigue damage and the fatigue life at the coupled micro-macroscopic scale based on the iterative variable in the (n+1)^{th} iteration of the crystal plasticity-based elastic-plastic constitutive model and the consistent tangent stiffness matrix.

6. The method for assessing the fatigue damage and the fatigue life based on the Abaqus according to claim 5, wherein, the lattice type in the step S21 comprises a face-centered cubic metal material, a body-centered cubic metal material, and a close-packed cubic metal material; a number of solution variables of the face-centered cubic metal material is 12; a number of solution variables of the body-centered cubic metal material is 48; and a number of solution variables of the close-packed cubic metal material is 6.
